(19) United States
(12) Patent Application Publication
(10) Pub. No.: US 2026/0116373 A1
(43) Pub. Date: Apr. 30, 2026

(54) VEHICLE DRIFT CONTROL APPARATUS AND METHOD IN WHICH DRIFT STATE STAGE IS SUBDIVIDED

(71) Applicants: Hyundai Motor Company, Seoul (KR); Kia Corporation, Seoul (KR); HYUNDAI MOBIS CO., LTD., Seoul (KR)

(72) Inventors: Jee Yong JUNG, Hwaseong-si (KR); Jin Ung PARK, Hwaseong-si (KR); Tae Soo KANG, Yongin-si (KR)

(73) Assignees: Hyundai Motor Company, Seoul (KR); Kia Corporation, Seoul (KR); HYUNDAI MOBIS CO., LTD., Seoul (KR)

(21) Appl. No.: 19/183,326

(22) Filed: Apr. 18, 2025

(30) Foreign Application Priority Data
Oct. 31, 2024 (KR) 10-2024-0152588

(51) Int. Cl. B60W 30/045; B60W 10/18; B60W 10/20

(52) U.S. Cl. CPC B60W 30/045; B60W 10/18; B60W 10/20; B60W 2520/14; B60W 2520/30; B60W 2540/10; B60W 2540/18; B60W 2720/30

(57) ABSTRACT

A vehicle drift control apparatus includes a controller configured to receive data of a plurality of drift state stages respectively corresponding to a plurality of different drift angle ranges, and to change a rear-wheel torque limiting stage of a vehicle as a drift state stage corresponding to a real-time drift angle of the vehicle is changed in a drift state of the vehicle.

### CROSS-REFERENCE TO RELATED APPLICATION(S)

The present application claims priority to Korean Patent Application No. 10-2024-0152588 filed on Oct. 31, 2024, the entire contents of which is incorporated herein for all purposes by this reference.

### BACKGROUND OF THE PRESENT DISCLOSURE

### Field of the Present Disclosure

The present disclosure relates to a vehicle drift control apparatus and method in which a drift state stage is subdivided.

### Description of Related Art

Vehicle drifting is a technique in which a driver intentionally slides rear wheels while maintaining control of a vehicle to maintain a high exit speed at a corner, causing the vehicle to pass through the corner in an oversteer state. For example, electric vehicles may implement the above-described vehicle drift by distributing torque only to a rear-wheel motor.

Vehicle drift has been increasingly considered for vehicle control, not only in entertainment for the fun of a driver while driving, but also for driving efficiency and stability in an environment with low ground friction.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle drift control apparatus and method configured for effectively assisting a driver in drift driving while securing vehicle drift safety, providing more delicate and smooth vehicle drift control by subdividing a drift state stage, or providing vehicle drift control more optimized for a will/skill level of the driver for drift driving.

According to an aspect of the present disclosure, there is provided a vehicle drift control apparatus including a controller configured to receive data of a plurality of drift state stages respectively corresponding to a plurality of different drift angle ranges, and to change a rear-wheel torque limiting stage of a vehicle as a drift state stage corresponding to a real-time drift angle of the vehicle is changed in a drift state of the vehicle.

The controller may be configured to change the rear-wheel torque limiting stage of the vehicle to lower a rear-wheel driving torque limit as the real-time drift angle increases and raise the rear-wheel driving torque limit of the vehicle as the real-time drift angle decreases.

The controller may be configured to raise a rear-wheel torque limit in a real-time rear-wheel torque limiting stage as a real-time accelerator pedal open value of the vehicle increases, and to lower the rear-wheel torque limit in the real-time rear-wheel torque limiting stage as the real-time accelerator pedal open value of the vehicle decreases.

The controller may be configured to change the rear-wheel torque limiting stage to further raise a rear-wheel torque limit of the vehicle to be higher than a torque upper bound when a real-time drift state stage is Drift state stage 0, adjust the rear-wheel torque limit of the vehicle to be closer to the torque upper bound than to a torque lower bound when the real-time drift state stage is Drift state stage 1, adjust the rear-wheel torque limit of the vehicle to be closer to the torque upper bound than to the torque lower bound when the real-time drift state stage is closer to Drift state stage 2, and adjust the rear-wheel torque limit of the vehicle to be closer to the torque lower bound than to the torque upper bound when the real-time drift state stage is closer to Drift state stage 3.

The controller may be configured to control real-time rear-wheel torque of the vehicle so that a real-time wheel slip of a real wheel of the vehicle is closer to a target wheel slip, when the real-time wheel slip is greater than the target wheel slip, to generate the target wheel slip, based on at least two of a real-time accelerator pedal open value, a real-time drift angle, a real-time drift angle change rate, and a real-time speed of the vehicle, and generate a second rear-wheel torque limit corresponding to the target wheel slip, and to determine a target rear-wheel driving torque value, based on a lower value among the rear-wheel torque limit and the second rear-wheel torque limit.

The controller may be configured to lower the rear-wheel torque limit of the vehicle as a steering angle of a front wheel of the vehicle increases when the real-time drift state stage is Drift state stage 0.

The controller may be configured to selectively further increase front-wheel torque of the vehicle when the real-time drift state stage is greater than Drift state stage 3, as compared to front-wheel torque of the vehicle when the real-time drift state stage is Drift state stage 3 or less than the Drift state stage 3.

The controller may be configured to further increase the front-wheel torque of the vehicle as a steering angle of a front wheel of the vehicle increases when the real-time drift state stage is greater than Drift state stage 2 and the vehicle is in a counter steering state.

The controller may be configured to selectively use braking torque control or vehicle dynamic control of the vehicle, depending on whether at least one of a real-time drift angle change rate, a yaw rate error, and a yaw acceleration of the vehicle is greater than a reference value.

The controller may be configured to increase braking torque of the vehicle as at least one of the real-time drift angle change rate, the yaw rate error, and the yaw acceleration of the vehicle increases. The controller may be configured to increase the braking torque of the vehicle as a real-time accelerator pedal value of the vehicle decreases. The controller may be configured to reduce braking torque of a front wheel and a rear wheel of the vehicle when the real-time drift angle of the vehicle is greater than a spin reference value.

The controller may be configured to receive a drift assist level. The controller may be configured to change whether to use braking torque control or vehicle dynamic control of the vehicle, or to adjust a control intensity of braking torque control or vehicle dynamic control of the vehicle, depending on the received drift assist level, when at least one of the real-time drift angle change rate, the yaw rate error, and the yaw acceleration of the vehicle is greater than the reference value.

The controller may be configured to receive a drift assist level. The controller may be configured to selectively change whether to use front-wheel torque control of the vehicle or to selectively adjust a control intensity of front-wheel torque control of the vehicle, depending on the received drift assist level, when the real-time drift state stage is greater than Drift state stage 3.

The controller may be configured to receive a drift assist level. The controller may be configured to adjust at least one of the torque upper bound and the torque lower bound, depending on the received drift assist level.

The controller may be configured to receive a drift assist level. The controller may be configured to adjust a rear-wheel torque limit in at least one of the plurality of drift state stages, depending on the received drift assist level.

According to another aspect of the present disclosure, there is provided a vehicle drift control method including monitoring a real-time drift angle of a vehicle receiving data of a plurality of drift state stages respectively corresponding to a plurality of different drift angle ranges in a drift state of the vehicle, and changing a rear-wheel torque limiting stage of the vehicle as a drift state stage corresponding to a real-time drift angle of the vehicle is changed.

The changing may include selectively increasing front-wheel torque of the vehicle, depending on a real-time drift state stage.

The changing may include lowering a rear-wheel torque limit of the vehicle or further increasing the front-wheel torque of the vehicle as a steering angle of a front wheel of the vehicle increases in a counter steering state.

The changing may include selectively using braking torque control or vehicle dynamic control of the vehicle, depending on whether at least one of a real-time drift angle change rate, a yaw rate error, and a yaw acceleration of the vehicle is greater than a reference value.

The changing may include raising a rear-wheel torque limit in a real-time rear-wheel torque limiting stage as a real-time accelerator pedal open value of the vehicle increases, and lowering the rear-wheel torque limit in the real-time rear-wheel torque limiting stage as the real-time accelerator pedal open value of the vehicle decreases.

A storage medium may record one or more programs including instructions for executing the vehicle drift control method.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a diagram illustrating a vehicle including a vehicle drift control apparatus according to an exemplary embodiment of the present disclosure.

FIG. 2 is a flowchart illustrating drift control in which drift state stages of a vehicle drift control apparatus and method are subdivided according to exemplary embodiment of the present disclosure.

FIG. 3 is a diagram illustrating a drift state and a rear-wheel torque limit by time during a vehicle drift process.

FIG. 4 is a flowchart illustrating additional control of a vehicle drift control apparatus and method, when a drift state stage is high, according to an exemplary embodiment of the present disclosure.

FIG. 5 is a diagram illustrating front-wheel torque control of a vehicle drift control apparatus and method according to an exemplary embodiment of the present disclosure.

FIG. 6 is a flowchart illustrating a process of determining, by a vehicle drift control apparatus and method, a target wheel slip for wheel slip-based torque control according to an exemplary embodiment of the present disclosure.

FIG. 7 is a graph illustrating a change in a vehicle drift process of a target wheel slip for wheel slip-based torque control of a vehicle drift control apparatus and method according to an exemplary embodiment of the present disclosure.

FIG. 8 is a diagram illustrating a drift assist level input/output and displayed by a vehicle drift control apparatus and method according to an exemplary embodiment of the present disclosure.

FIG. 9 is a diagram illustrating a drift assist level changed and displayed by a vehicle drift control apparatus and method according to an exemplary embodiment of the present disclosure.

FIG. 10 is a flowchart illustrating a process of adjusting, by a vehicle drift control apparatus and method, a control intensity (and/or presence or absence) depending on a received drift assist level according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Various modifications may be made to the example embodiments. Here, the example embodiments should not be construed as being limited to the present disclosure and should be understood to include all changes, equivalents, and replacements within the idea and the technical scope of the present disclosure.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terminology used herein is for describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in the present disclosure, specify the presence of stated features, integers, operations, operations, elements, components or a combination thereof, but do not preclude the presence or addition of one or more other features, integers, operations, operations, elements, components, and/or groups thereof.

Unless otherwise defined herein, all terms used herein, including technical or scientific terms, have the same meanings as those generally understood by one of ordinary skill in the art. Terms defined in dictionaries generally used should be construed to have meanings matching contextual meanings in the related art and are not to be construed as having an ideal or excessively formal meaning, unless otherwise defined herein.

As used herein, a vehicle refers to various vehicles transporting a transported object such as a person, animal, or object from a starting point to a destination. Such vehicles are not limited to vehicles travelling on roads or tracks.

Hereinafter, example embodiments of the present disclosure will be described in more detail with reference to the accompanying drawings.

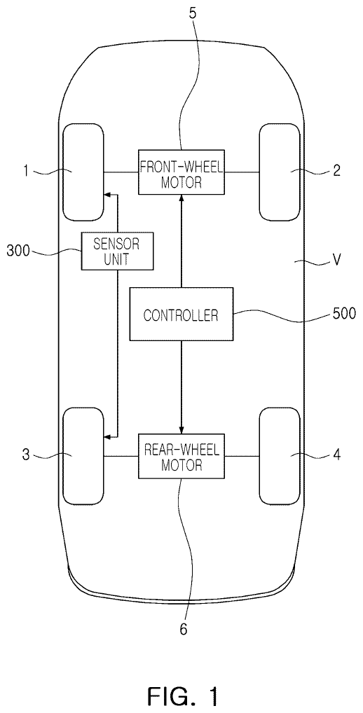

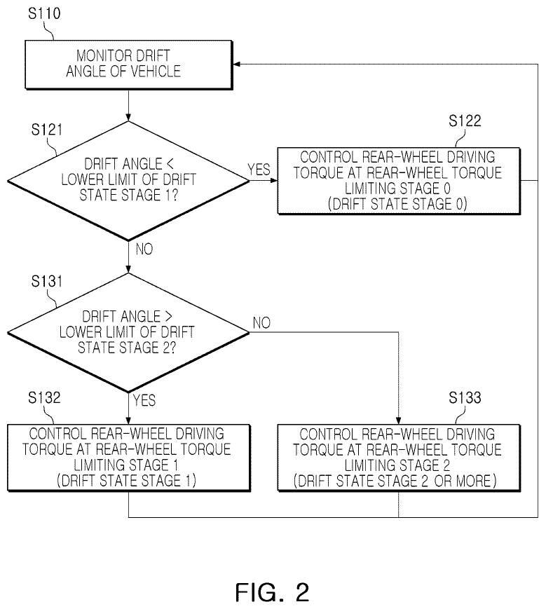

Referring to FIG. 1 and FIG. 2, a vehicle drift control apparatus according to an exemplary embodiment of the present disclosure may include a controller 500 receiving data of a plurality of drift state stages respectively corresponding to a plurality of different drift angle ranges, and changing (for example, raising rear-wheel torque limiting stage 0 to Rear-wheel torque limiting stage 2 and lowering Rear-wheel torque limiting stage 2 to Rear-wheel torque limiting stage 0) a rear-wheel torque limiting stage (for example, a rear-wheel driving torque limit) of a vehicle V as a drift state stage corresponding to a real-time drift angle of the vehicle V is changed (for example, raising Drift state stage 0 to Drift state stage 2 and lowering Drift state stage 2 to Drift state stage 0) in a drift state of the vehicle V. A vehicle drift control method according to an exemplary embodiment of the present disclosure may include an operation (S110) of monitoring a real-time drift angle of a vehicle V in a drift state of the vehicle V, and operations (S121, S122, S131, S132, and S133) of changing a rear-wheel torque limiting stage (for example, a rear-wheel driving torque limit) of the vehicle V as a drift state stage corresponding to the real-time drift angle of the vehicle V is changed.

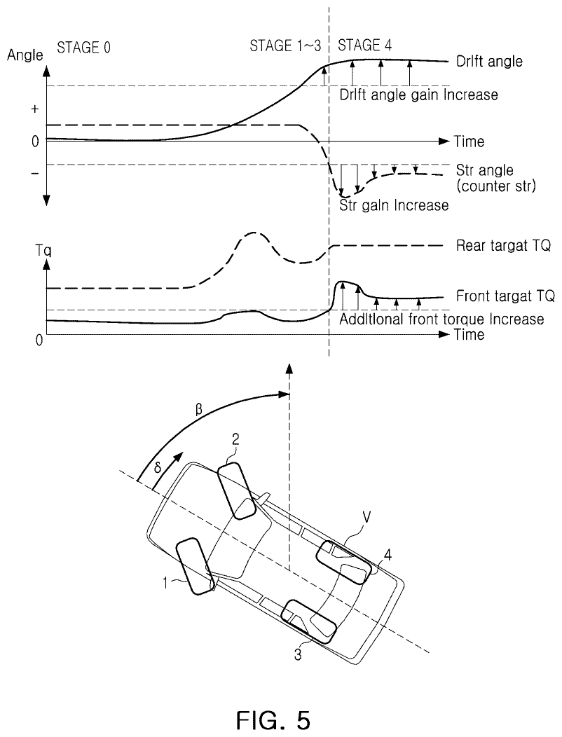

A drift angle may be defined as an angle (β in FIG. 5) formed by a posture direction of the vehicle V (a direction in which rear wheels 3 and 4 oppose front wheels 1 and 2) and a movement direction (a vector direction of speed) of the vehicle V. For example, when the vehicle V is in a grip state in which the vehicle V does not slide, the vehicle V may move only by rotation of the rear wheels 3 and 4 and/or the front wheels 1 and 2, and thus the posture direction and the movement direction of the vehicle V may be the same (a drift angle of 0°). For example, when the vehicle V makes a left turn or a right turn in the grip state, an acceleration direction and a movement direction of the vehicle V may be different from each other, but a posture direction and a movement direction at each point of a movement trajectory of the vehicle V may be the same. For example, when the vehicle V slides in a straight line, a direction in which the vehicle V slides may be the same as a posture direction of the vehicle V, and a drift angle may be 0°.

For example, when the vehicle V slides while making a left or right turn, a direction in which the vehicle V slides may be a direction in which the vehicle V deviates from a rotational movement trajectory of the vehicle V, and thus may be different from a posture direction at each point of the rotational movement trajectory of the vehicle V. In the instant case, a drift angle may be greater than 0°, and the vehicle V may be in a drift state. A further increase in the drift angle may be due to the rear wheels 3 and 4 sliding more strongly than the front wheels 1 and 2 (stronger lateral slip).

As the vehicle V more strongly drifts, the drift angle may further increase, and higher safety may be required for the vehicle V. Lateral slip of the rear wheels 3 and 4 may be more safely controlled as driving torque of the rear wheels 3 and 4 decreases. When the rear wheels 3 and 4 have excessively small driving torque as compared to a drift intensity of the vehicle V, a state of the vehicle V may be too easily switched from a drift state to a grip state so that drift driving of a driver may not be properly assisted, and a will/skill level of the driver for drift driving may not be properly reflected in drift control.

The controller 500 may change a drift state stage in real time depending on a real-time drift intensity (corresponding to a drift angle) of the vehicle V, and may be configured for controlling the driving torque of the rear wheels 3 and 4 depending on a rear-wheel driving torque limit level adjusted to the real-time drift state stage. Accordingly, the vehicle drift control apparatus according to an exemplary embodiment of the present disclosure may effectively assist the driver in drift driving while securing drift safety of the vehicle V, may provide more delicate and smooth vehicle drift control by subdividing the drift state stage, or may properly reflect a will/skill level of the driver for drift driving in drift control.

For example, as the real-time drift angle increases, the controller 500 may lower a rear-wheel torque limit (for example, a rear-wheel driving torque limit) of the vehicle V to focus more on safety of the vehicle V. For example, as the real-time drift angle decreases, the controller 500 may raise the rear-wheel torque limit of the vehicle V, preventing the state of the vehicle V from being too easily switched from the drift state to the grip state, and effectively assisting the driver in drift driving.

For example, a sensor unit 300 may include a longitudinal speed sensor configured for detecting a longitudinal speed of the vehicle V, and a lateral speed sensor configured for detecting a lateral speed of the vehicle V. For example, the controller 500 may be configured to determine a movement direction of the vehicle V, based on the longitudinal speed, the lateral speed, and a trigonometric function, and may be configured to determine an angle formed by a longitudinal direction and the determined movement direction as a drift angle, but the present disclosure is not limited thereto. For example, the controller 500 may be configured to determine the drift angle, based on at least some of a yaw rate, a steering angle, acceleration, inertia, a mass, a dimension, and the like of the vehicle V instead of a speed of the vehicle V, and the sensor unit 300 may include at least some sensors, among various sensors for detecting the yaw rate, the steering angle, the acceleration, the inertia, the mass, the dimension, and the like of the vehicle V.

For example, the controller 500 may be configured for controlling driving torque of the rear wheels 3 and 4 by controlling driving torque of a rear-wheel motor 6. For example, the controller 500 may further control torque of a front-wheel motor 5, and may be configured for controlling torque of the front wheels 1 and 2. For example, the controller 500 may transmit a rear-wheel torque limit and/or a current command signal to the rear-wheel motor 6, based on determined rear-wheel torque limit state information. For example, each of the rear-wheel motor 6 and the front-wheel motor 5 may include not only a motor but also an inverter/rectifier, and the controller 500 may be configured to control the inverter/rectifier (for example, switching control of a switching device), or may be implemented as an electronic control unit (ECU), but the present disclosure is not limited thereto.

For example, the sensor unit 300 may execute a monitoring operation (S110), and the controller 500 may verify whether a drift angle is less than a lower limit of Drift state stage 1 (S121), may set a drift state stage to Drift state stage 0 when the drift angle is less than the lower limit of Drift state stage 1 to control rear-wheel driving torque at Rear-wheel torque limiting stage 0 (S122), may verify whether the drift angle is less than a lower limit of Drift state stage 2 when the drift angle is greater than or equal to the lower limit of Drift state stage 1 (S131), may set the drift state stage to Drift state stage 1 when the drift angle is less than the lower limit of Drift state stage 2 to control the rear-wheel driving torque so that a rear-wheel torque limiting stage is transited from 0 to 1 (S132), may set the drift state stage to Drift state stage 2 when the drift angle is greater than or equal to the lower limit of Drift state stage 2 to control the rear-wheel driving torque at Rear-wheel torque limiting stage 2 (S133), and may set the drift state stage to drift state stage 3 when the drift angle is greater than or equal to the lower limit of Drift state stage 2 and rapidly increases to control the rear-wheel driving torque at Rear-wheel torque limiting stage 2 (S133).

Drift state stage 0 may be a substantially non-drift state or a low-level (or low-intensity) drift state. Drift state stage 1 may be a state close to drift or an intermediate-level (or intermediate-intensity) drift state. Drift state stage 2 may a complete drift state or a high-level (or high-intensity) drift state. For example, data of a plurality of drift state stages provided in advance by the controller (500 in FIG. 1) may include a lower limit (and/or an upper limit) for determining whether there is a change between Drift state stages 0, 1 and 2, and may be a constant or a function.

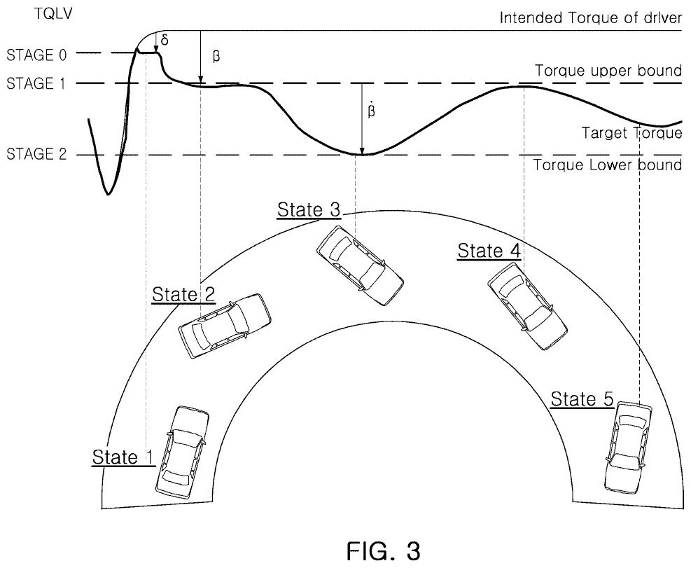

Referring to FIG. 2 and FIG. 3, the controller (500 in FIG. 1) may change a rear-wheel torque limiting stage (TQLV) to further raise a rear-wheel torque limit (for example, a rear-wheel driving torque limit) of a vehicle when a real-time drift state stage is Drift state stage 0, to adjust the rear-wheel torque limit of the vehicle to be closer to a torque upper bound than to a torque lower bound when the real-time drift state stage is in Drift state stage 1, and to adjust the rear-wheel torque limit of the vehicle to be closer to the torque lower bound than to the torque upper bound as a drift angle rapidly increases when the real-time drift state stage is greater than or equal to Drift state stage 2.

For example, the torque upper bound and the torque lower bound may be included in data of a plurality of drift state stages provided in advance by the controller (500 in FIG. 1), and may be a constant or a function including a road friction coefficient and/or a vehicle speed as a variable.

In the operations (S121, S122, S131, S132, and S133 in FIG. 2) of changing the rear-wheel torque limiting stage, the controller (500 in FIG. 1) may raise a rear-wheel torque limit (for example, the rear-wheel driving torque limit) in a real-time rear-wheel torque limiting stage as a real-time accelerator pedal open value of the vehicle increases, and may lower the rear-wheel torque limit in the real-time rear-wheel torque limiting stage as the -time accelerator pedal open value of the vehicle decreases. For example, the controller (500 in FIG. 1) may be configured to determine intended torque of driver (unit: Nm) by multiplying maximum motor torque (unit: Nm) of a rear-wheel motor (6 in FIG. 1) by the real-time accelerator pedal open value (unit: %), and may be configured to determine a torque upper bound and a torque lower bound obtained by multiplying the intended torque of driver by preset weights, respectively. The real-time accelerator pedal open value may be affected by a will/skill level of the driver, and the controller (500 in FIG. 1) may be configured to determine the rear-wheel torque limit, based on the real-time accelerator pedal open value, further optimizing a will/skill level of drift of the driver and reflecting the will/skill level of drift of the driver in drift control.

For example, in a process of one-time drift (for example, 180-degree rotational drift), a state of the vehicle may be changed in the order of State 1, State 2, State 3, State 4, and State 5.

State 1 may correspond to Drift state stage 0. For example, when the real-time drift state stage is Drift state stage 0, the controller (500 in FIG. 1) may lower the rear-wheel torque limit (for example, the rear-wheel driving torque limit) of the vehicle as a steering angle δ of a front wheel of the vehicle increases. Higher safety of the vehicle may be required as the steering angle & increases.

A state between State 1 to State 2 may correspond to Drift state stage 1, and the controller (500 in FIG. 1) may converge the rear-wheel torque limit to the torque upper bound, properly satisfying drift safety and a degree of freedom of drift driving of the driver.

State 4 may correspond to Drift state stage 2, and may be a state in which State 3 in which the drift angle rapidly increases returns to a state in which the drift angle decreases and is maintained or slowly increases.

State 5 may correspond to Drift state stage 2, and may be an intermediate state in which State 4 returns to State 3. State 3 may correspond to Drift state stage 3, and the controller (500 in FIG. 1) may converge the rear-wheel torque limit (for example, the rear-wheel driving torque limit) to the torque lower bound, securing drift safety (for example, spin-out prevention). Furthermore, the controller (500 in FIG. 1) may not excessively lower the rear-wheel torque limit, preventing a state of the vehicle from being too easily switched from a drift state to a grip state.

For example, the sensor unit (300 in FIG. 1) may include a steering angle sensor configured for detecting rotation of a steering wheel of the driver, and an accelerator pedal sensor configured for detecting an accelerator pedal open value (for example, pressure) of the driver. The controller (500 in FIG. 1) may adjust the rear-wheel torque limit, based on a steering angle δ sensed by the steering angle sensor and an accelerator pedal open value (for example, pressure) sensed by the accelerator pedal sensor.

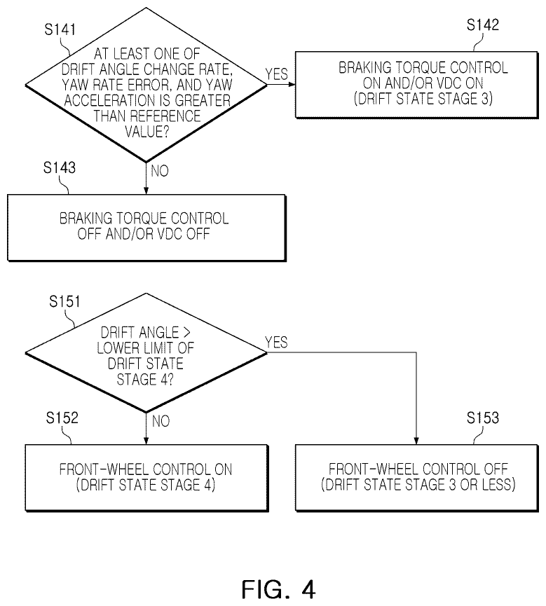

FIG. 4 is a flowchart illustrating operations in which not only Drift state stage 2 but also Drift state stages 3 and/or 4 are added to the operations (S121, S122, S131, S132, and S133 in FIG. 2) of changing the rear-wheel torque limiting stage. Referring to FIG. 4, in the operations of changing the rear-wheel torque limiting stage, the controller (500 in FIG. 1) may selectively use braking torque control or vehicle dynamic control (VDC) of the vehicle V (S142 and S143), depending on whether at least one of a real-time drift angle change rate, a yaw rate error, and a yaw acceleration of the vehicle V is greater than a reference value (S141).

For example, the sensor unit (300 in FIG. 1) may include a yaw rate sensor configured for detecting horizontal rotation (yaw rate) of the vehicle V and a steering angle sensor configured for detecting steering wheel rotation (steering angle) of a driver. The controller (500 in FIG. 1) may be configured to determine a yaw acceleration, based on the yaw rate sensed by the yaw rate sensor, and may be configured to determine a yaw rate error (a difference between the yaw rate and the steering angle), based on the yaw rate and the steering angle sensed by the steering angle sensor.

For example, the reference value may include various reference values for each of the real-time drift angle change rate, the yaw rate error, and the yaw acceleration, and may be a constant or a function. When the reference value is a function, the reference value may be a function including a road friction coefficient and/or a drift assist level (control intensity) as a variable.

When at least one of the real-time drift angle change rate, the yaw rate error, and the yaw acceleration of the vehicle V is greater than the reference value, drift of the vehicle V may be in an unstable state. Accordingly, in a state in which drift of the vehicle V is unstable, the controller (500 in FIG. 1) may add braking torque control and/or VDC in addition to driving torque control, rapidly securing safety of the vehicle V to rapidly stabilize drift.

For example, the controller (500 in FIG. 1) may increase braking torque of the vehicle V as at least one of the real-time drift angle change rate, the yaw rate error, and the yaw acceleration of the vehicle V increases, which may be an example of the VDC.

For example, when the real-time drift state stage is greater than or equal to Drift state stage (S133) and a real-time drift angle of the vehicle V exceeds a spin reference value, the controller (500 in FIG. 1) may reduce braking torque of the front wheels (1 and 2 in FIG. 1) and the rear wheels (3 and 4 in FIG. 1) of the vehicle, which may be an example of the VDC. The spin reference value may be higher than an upper limit of Drift state stage 2.

For example, the controller (500 in FIG. 1) may increase braking torque of the vehicle V as a real-time accelerator pedal open value of the vehicle V decreases, which may be an example of controlling the braking torque. In a state in which drift of the vehicle V is strong, as a drift will/skill level of the driver is lowered, it may be difficult for the driver to apply pressure to an accelerator pedal, or the driver may wish to weaken drift. The controller (500 in FIG. 1) may increase the braking torque of the vehicle V as the real-time accelerator pedal open value decreases, further optimizing the drift will/skill level of the driver and reflecting the drift will/skill level of the driver in drift control.

Referring to FIG. 4, the controller (500 in FIG. 1) may verify whether a drift angle is less than a lower limit of Drift state stage 4 (S151), may use front-wheel torque control by setting a drift state stage to Drift state stage 2 or 3 when the drift angle is less than the lower limit of Drift state stage 4 (S153), and may use front-wheel torque control by setting the drift state stage to Drift state stage 4 when the drift angle is greater than or equal to the lower limit of Drift state stage 4 (S152).

That is, the controller (500 in FIG. 1) may selectively further increase front-wheel torque of the vehicle V when a real-time drift state stage is greater than Drift state stage 3 (S142, S143, S152, and S153), as compared to front-wheel torque of the vehicle V when the real-time drift state stage is less than or equal to Drift state stage 3 (S122, S132, and S133 in FIG. 2). The operations (S121, S122, S131, S132, and S133 in FIG. 2) of changing the rear-wheel torque limiting stage may include selectively increasing front-wheel torque of the vehicle V, depending on the real-time drift state stage.

Drift state stage 4 may be a drift state (for example, spin-out) in which it is difficult for the driver to properly control the vehicle V, or may be an ultra-high level (or ultra-high intensity) drift state. In the instant case, the controller (500 in FIG. 1) may maintain a rear-wheel torque limit (for example, a rear-wheel driving torque limit) of Drift state stage 2 or 3, and may add front-wheel torque control (for example, a front-wheel driving torque increase), rapidly securing safety of the vehicle V to rapidly stabilize drift.

Referring to FIG. 5, in a process of one-time drift, a drift angle may gradually increase, and a real-time drift state stage may be changed in the order of Drift state stages 0, 1, 2 (or 3), and 4. In the instant case, a rear-wheel torque limit (rear target TQ) may be converged (overshootable before convergence) to a rear-wheel torque limit (rear target TQ) of Drift state stage 2 or 3, and front-wheel torque (front target TQ) may rise after being changed from Drift state stage 2 or 3 to Drift state stage 4.

Referring to FIG. 5, when the real-time drift state stage is greater than Drift state stage 3 (for example, Drift state stage 4) and the vehicle V is in a counter steering state (a state in which a drift angle and a steering angle δ are opposite to each other), the controller (500 in FIG. 1) may further increase front-wheel torque of the vehicle V as a steering angle δ of the front wheels 1 and 2 of the vehicle V increases. The operations (S121, S122, S131, S132, and S133 in FIG. 2) of changing the rear-wheel torque limiting stage may include lowering a rear-wheel torque limit (for example, a rear-wheel torque limit in Drift state stage 2 or 3) of the vehicle V or further increasing the front-wheel torque of the vehicle V (for example, increasing front-wheel torque in Drift state stage 4).

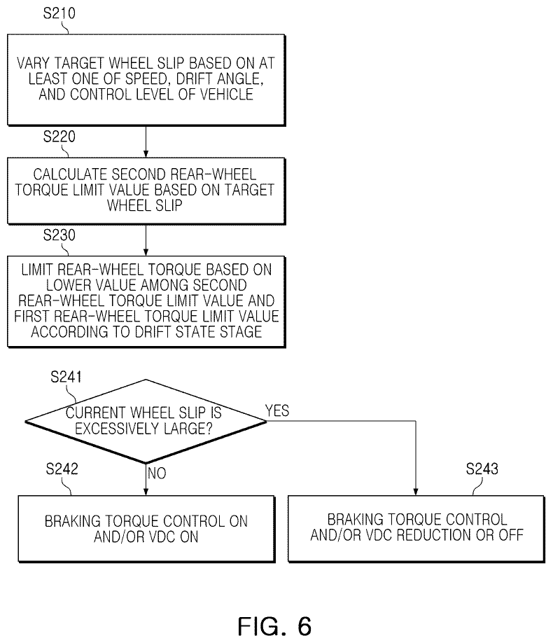

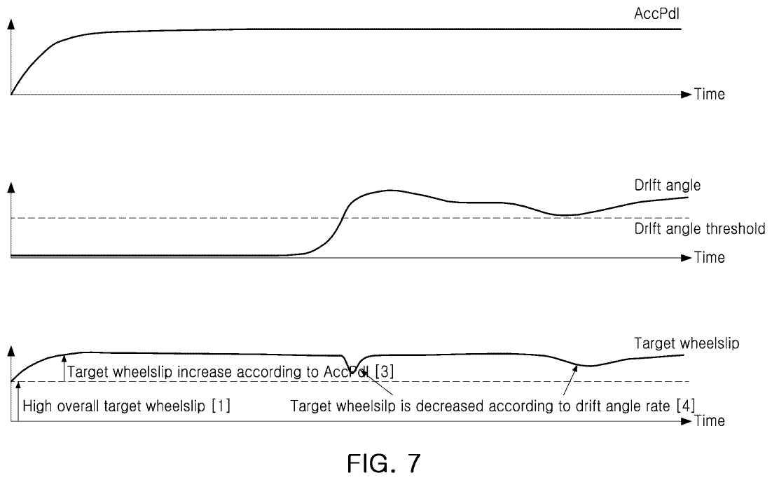

Referring to FIG. 6 and FIG. 7, the controller (500 in FIG. 1) may be configured to generate a first rear-wheel torque limit according to a rear-wheel torque limiting stage of the vehicle, may be configured for controlling real-time rear-wheel torque of the vehicle so that a real-time wheel slip (e.g., a real-time drive wheel slip) of a real wheel of the vehicle is closer to a target wheel slip (e.g., a target drive wheel slip), when the real-time wheel slip of the vehicle is greater than the target wheel slip, may be configured to generate the target wheel slip, based on a real-time accelerator pedal open value (AccPdl) or a speed of the vehicle, may be configured to generate a second rear-wheel torque limit corresponding to the target wheel slip (S210 and S220), and may be configured to determine a target rear-wheel driving torque value, based on a lower value among the first rear-wheel torque limit and the second rear-wheel torque limit (S230).

For example, the sensor (300 in FIG. 1) may include a wheel speed sensor configured for detecting wheel speeds of the rear wheels 3 and 4 and/or the front wheels 1 and 2. When the real-time wheel slip is a slip ratio (unit: %), the controller (500 in FIG. 1) may be configured to determine a real-time wheel slip (numerator/denominator) by dividing a value (numerator) obtained by subtracting a real-time wheel speed sensed by the wheel speed sensor from a real-time longitudinal speed sensed by the sensor unit 300 by the real-time wheel speed (denominator).

Referring to FIG. 7, in a process of one-time drift, the real-time accelerator pedal open value (AccPdl) of the vehicle may be raised and saturated to a specific value, and the target wheel slip may be generally (only when the second rear-wheel torque limit is lower than the first rear-wheel torque limit) raised and saturated to a specific value depending on the real-time accelerator pedal open value (AccPdl). For example, the second rear-wheel torque limit may vary based on at least one of a speed (corresponding to the real-time accelerator pedal open value (AccPdl)), a drift angle, and a control level (corresponding to a control intensity and a drift assist level) of the vehicle, and may be further affected by the speed than by the drift angle and the control level.

The drift angle may be rapidly changed at an intermediate point in time in a process of one-time drift. When the drift angle rapidly increases, the first rear-wheel torque limit may be lower than the second rear-wheel torque limit, and thus the target rear-wheel torque value may be lowered for a short time period at the intermediate point in time in the one-time drift process.

For example, the controller (500 in FIG. 1) may be configured to determine whether a real-time braking wheel slip is excessively large (S241), may use braking torque control and/or VDC when the real-time wheel slip is not excessively large (S242), and may lower braking torque control and/or VDC or may not use braking torque control and/or VDC when the real-time wheel slip is excessively large (S243).

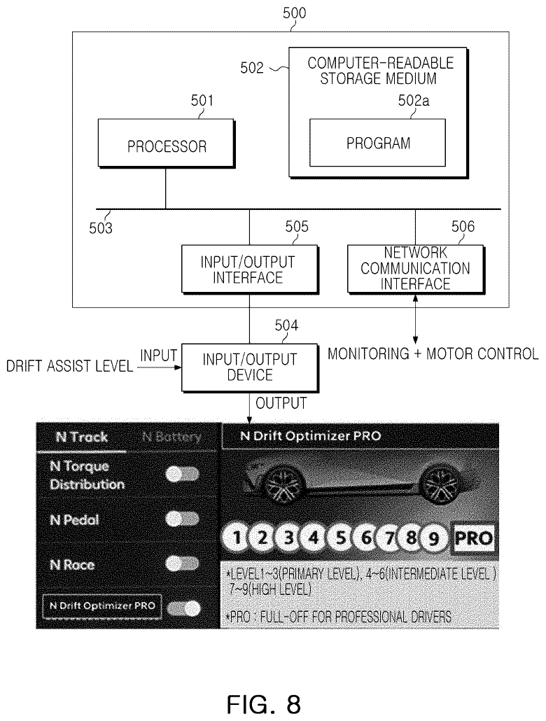

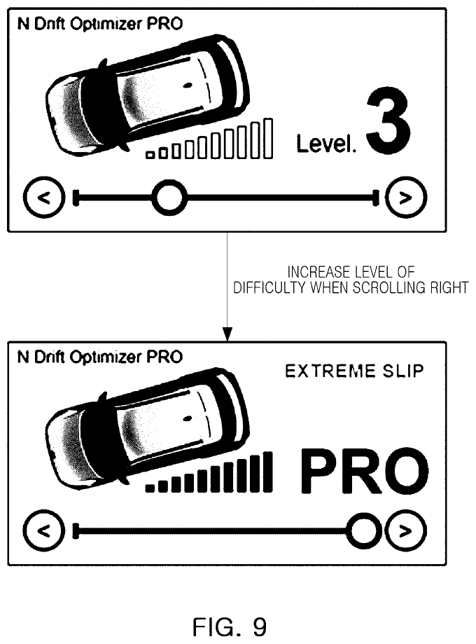

Referring to FIG. 8 and FIG. 9, the controller 500 may receive a drift assist level, and may output and display the drift assist level and a level change.

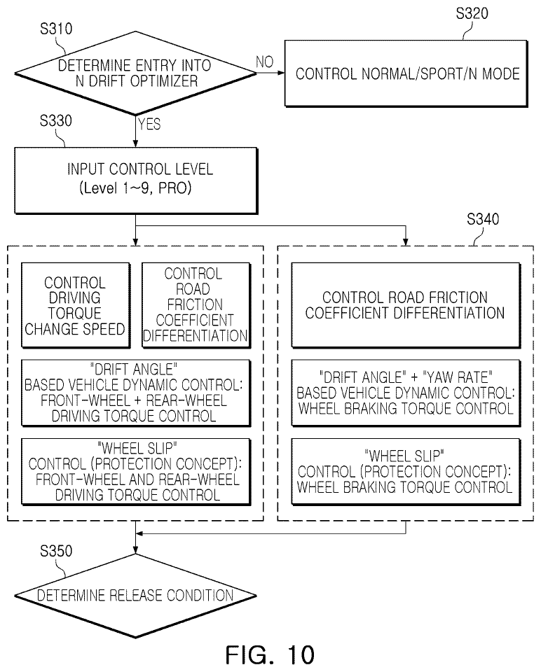

Referring to FIG. 10, the controller (500 in FIG. 8) may be configured to determine whether the vehicle is in a drift state (S310), may be configured for controlling rear wheels and/or front wheels in a normal mode (for example, electronic stability control (ESC)) when the vehicle is not in the drift state (S320), may adjust a rear-wheel torque limit in at least one of a plurality of drift state stages depending on a pre-received (S330) control level (corresponding to the drift assist level) when the vehicle is in the drift state (S340), and may be configured to determine a drift release condition (for example, priority use of a normal mode based on a driver input) (S350).

For example, the controller (500 in FIG. 8) may adjust at least one of a torque upper bound (see FIG. 3) and a torque upper bound (see FIG. 3), depending on the received drift assist level.

For example, when at least one of a real-time drift angle change rate, a yaw rate error, and a yaw acceleration of the vehicle is greater than a reference value (corresponding to S142 in FIG. 4), the controller (500 in FIG. 8) may change whether to use braking torque control or VDC of the vehicle or adjust a control intensity of braking torque control or VDC of the vehicle, depending on the received drift assist level. For example, the controller (500 in FIG. 8) may not apply braking torque control or VDC to drift control when the drift assist level is a PRO. When the drift assist level is one of 1 to 9 rather than the PRO, the controller (500 in FIG. 8) may further increase a control intensity (for example, lowering a rear-wheel driving torque limit) as the drift assist level is lowered.

For example, when a real-time drift state stage is greater than Drift state stage 3 (corresponding to S142, S143, and S152 in FIG. 4), the controller may selectively change whether to use front-wheel torque control of the vehicle or adjust a control intensity of front-wheel torque control of the vehicle, depending on the received drift assist level. For example, the controller (500 in FIG. 8) may not apply front-wheel torque control to drift control when the drift assist level is a PRO. When the drift assist level is one of 1 to 9 rather than the PRO, the controller may further increase the control intensity (for example, further increasing an increase in front-wheel driving torque) as the drift assist level is lowered.

Referring to FIG. 8, a controller 500 of a vehicle drift control apparatus according to an exemplary embodiment of the present disclosure may be implemented as a computing system including at least one processor 501, a computer-readable storage medium 502, and a communication bus 503. For example, the controller 500 may be implemented as a microcontroller or an embedded system. The storage medium 502 may record one or more programs including instructions for executing a vehicle drift control method according to an exemplary embodiment of the present disclosure. The communication bus 503 may interconnect various other components of the controller 500, including the processor 501 and the computer-readable storage medium 502.

The processor 501 may cause the controller 500 to operate according to the example embodiments described above. For example, the processor 501 may execute one or more programs stored in the computer-readable storage medium 502. The one or more programs may include one or more computer-executable instructions. When executed by the processor 501, the one or more computer-executable instructions may be configured to cause the controller 500 to perform operations according to example embodiments.

The computer-readable storage medium 502 may be configured to store the computer-executable instructions or program code, program data, and/or other suitable forms of information. A program 502a, stored in the computer-readable storage medium 502, may include a set of instructions executable by the processor 501. In an example embodiment, the computer-readable storage medium 502 may be a memory (a volatile memory such as a random access memory, a non-volatile memory, or any suitable combination thereof), one or more magnetic disk storage devices, optical disk storage devices, flash memory devices, other types of storage media that are accessible by the controller 500 and are configured for storing desired information, or any suitable combinations thereof.

The controller 500 may also include one or more input/output interfaces 505 providing an interface for one or more input/output devices 504, and one or more network communication interfaces 506. The input/output interface 505 and the network communication interface 506 may be connected to the communication bus 503. A network may be one of a cellular network, such as global system for mobile communications (GSM), enhanced data rates for GSM evolution (EDGE), general packet radio service (GPRS), Code Division Multiple Access (CDMA), time division-CDMA (TD-CDMA), Universal Mobile Telecommunications System (UMTS), or long-term evolution (LTE), or another cellular network, and may be implemented as Ethernet, media-oriented systems transport (MOST), Flexray, Controller Area Network (CAN), Local Interconnect Network (LIN), Internet, Bluetooth, Near Field Communication (NFC), Zigbee®, radio frequency (RF), or the like.

The input/output device 504 may be connected to other components of the controller 500 through the input/output interface 505. The exemplary input/output device 504 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 504 may be included in the controller 500 as a component included in the controller 500, or may be connected to the controller 500 as a device, distinct from the controller 500.

Example embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the exemplary embodiments of the present disclosure, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code which may be executed by the computer using an interpreter.

A vehicle drift control apparatus and method according to an exemplary embodiment of the present disclosure may effectively assist a driver in drift driving while securing vehicle drift safety, provide more delicate and smooth vehicle drift control by subdividing a drift state stage, or provide vehicle drift control more optimized for a will/skill level of the driver for drift driving.

The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle drift control apparatus comprising:
a controller configured to receive data of a plurality of drift state stages respectively corresponding to a plurality of different drift angle ranges, and to change a rear-wheel torque limiting stage of a vehicle based on that a drift state stage corresponding to a real-time drift angle of the vehicle among the plurality of drift state stages is changed in a drift state of the vehicle.

2. The vehicle drift control apparatus of claim 1, wherein the controller is further configured to change the rear-wheel torque limiting stage of the vehicle to:
lower a rear-wheel driving torque limit of the vehicle based on that the real-time drift angle increases and
raise the rear-wheel driving torque limit of the vehicle based on that the real-time drift angle decreases.

3. The vehicle drift control apparatus of claim 2, wherein the controller is further configured:
to raise a rear-wheel torque limit in a real-time rear-wheel torque limiting stage based on that a real-time accelerator pedal open value of the vehicle increases, and
to lower the rear-wheel torque limit in the real-time rear-wheel torque limiting stage based on that the real-time accelerator pedal open value of the vehicle decreases.

4. The vehicle drift control apparatus of claim 2, wherein the controller is further configured to change the rear-wheel torque limiting stage to further:
raise a rear-wheel torque limit of the vehicle to be higher than a torque upper bound based on that a real-time drift state stage among the plurality of drift state stages is Drift state stage 0,
adjust the rear-wheel torque limit of the vehicle to be closer to the torque upper bound than to a torque lower bound based on that the real-time drift state stage is Drift state stage 1,
adjust the rear-wheel torque limit of the vehicle to be closer to the torque upper bound than to the torque lower bound based on that the real-time drift state stage is closer to Drift state stage 2, and
adjust the rear-wheel torque limit of the vehicle to be closer to the torque lower bound than to the torque upper bound based on that the real-time drift state stage is closer to Drift state stage 3.

5. The vehicle drift control apparatus of claim 4, wherein the controller is further configured to:
control a real-time rear-wheel torque of the vehicle so that a real-time wheel slip of a real wheel of the vehicle is closer to a target wheel slip, based on that the real-time wheel slip is greater than the target wheel slip;
generate the target wheel slip, based on at least two of a real-time accelerator pedal open value, a real-time drift angle, a real-time drift angle change rate, and a real-time speed of the vehicle, and generate a second rear-wheel torque limit corresponding to the target wheel slip; and
determine a target rear-wheel driving torque value, based on a lower value among the rear-wheel torque limit and the second rear-wheel torque limit.

6. The vehicle drift control apparatus of claim 4, wherein the controller is further configured to lower the rear-wheel torque limit of the vehicle based on that a steering angle of a front wheel of the vehicle increases based on that the real-time drift state stage is the Drift state stage 0.

7. The vehicle drift control apparatus of claim 4, wherein the controller is further configured to selectively further increase a front-wheel torque of the vehicle based on that the real-time drift state stage is greater than the Drift state stage 3, based on that compared to the front-wheel torque of the vehicle based on that the real-time drift state stage is the Drift state stage 3 or less than the Drift state stage 3.

8. The vehicle drift control apparatus of claim 7, wherein the controller is further configured to further increase the front-wheel torque of the vehicle based on that a steering angle of a front wheel of the vehicle increases based on that the real-time drift state stage is greater than the Drift state stage 2 and the vehicle is in a counter steering state.

9. The vehicle drift control apparatus of claim 1, wherein the controller is further configured to selectively use braking torque control or vehicle dynamic control of the vehicle, depending on whether at least one of a real-time drift angle change rate, a yaw rate error, and a yaw acceleration of the vehicle is greater than a reference value.

10. The vehicle drift control apparatus of claim 9,
wherein the controller is further configured to increase a braking torque of the vehicle based on that at least one of the real-time drift angle change rate, the yaw rate error, and the yaw acceleration of the vehicle increases,
wherein the controller is further configured to increase the braking torque of the vehicle based on that a real-time accelerator pedal value of the vehicle decreases, and
wherein the controller is further configured to reduce a braking torque of a front wheel and a rear wheel of the vehicle based on that the real-time drift angle of the vehicle is greater than a spin reference value.

11. The vehicle drift control apparatus of claim 9,
wherein the controller is further configured to receive a drift assist level, and
wherein the controller is further configured to change whether to use the braking torque control or the vehicle dynamic control of the vehicle, or to adjust a control intensity of the braking torque control or the vehicle dynamic control of the vehicle, depending on the received drift assist level, based on that at least one of the real-time drift angle change rate, the yaw rate error, and the yaw acceleration of the vehicle is greater than the reference value.

12. The vehicle drift control apparatus of claim 7,
wherein the controller is further configured to receive a drift assist level, and
wherein the controller is further configured to selectively change whether to use a front-wheel torque control of the vehicle or to selectively adjust a control intensity of the front-wheel torque control of the vehicle, depending on the received drift assist level, based on that the real-time drift state stage is greater than the Drift state stage 3.

13. The vehicle drift control apparatus of claim 4,
wherein the controller is further configured to receive a drift assist level, and
wherein the controller is further configured to adjust at least one of the torque upper bound and the torque lower bound, depending on the received drift assist level.

14. The vehicle drift control apparatus of claim 1,
wherein the controller is further configured to receive a drift assist level, and
wherein the controller is further configured to adjust a rear-wheel torque limit in at least one of the plurality of drift state stages, depending on the received drift assist level.

15. A vehicle drift control method comprising:
monitoring, by a controller, a real-time drift angle of a vehicle receiving data of a plurality of drift state stages respectively corresponding to a plurality of different drift angle ranges in a drift state of the vehicle; and
changing, by the controller, a rear-wheel torque limiting stage of the vehicle based on that a drift state stage corresponding to a real-time drift angle of the vehicle among the plurality of drift state stages is changed.

16. The vehicle drift control method of claim 15, wherein the changing includes selectively increasing a front-wheel torque of the vehicle, depending on a real-time drift state stage.

17. The vehicle drift control method of claim 16, wherein the changing further includes lowering a rear-wheel torque limit of the vehicle or further increasing the front-wheel torque of the vehicle based on that a steering angle of a front wheel of the vehicle increases in a counter steering state.

18. The vehicle drift control method of claim 17, wherein the changing further includes selectively using a braking torque control or a vehicle dynamic control of the vehicle, depending on whether at least one of a real-time drift angle change rate, a yaw rate error, and a yaw acceleration of the vehicle is greater than a reference value.

19. The vehicle drift control method of claim 18, wherein the changing further includes raising a rear-wheel torque limit in a real-time rear-wheel torque limiting stage based on that a real-time accelerator pedal open value of the vehicle increases, and lowering the rear-wheel torque limit in the real-time rear-wheel torque limiting stage based on that the real-time accelerator pedal open value of the vehicle decreases.

20. A non-transitory storage medium recording one or more programs including instructions for executing the vehicle drift control method of claim 15.
